(19) United States
(12) Patent Application Publication
(10) Pub. No.: US 2020/0009943 A1
(43) Pub. Date: Jan. 9, 2020

(54) ELECTRICAL HEATING APPARATUS

(71) Applicant: Webasto SE, Stockdorf (DE)

(72) Inventors: CHRISTIAN BAECKER, Stockdorf (DE); PETER NEIDENBERGER, Stockdorf (DE); TOBIAS PFANNENSTIEL, Stockdorf (DE)

(21) Appl. No.: 16/488,285

(22) PCT Filed: Mar. 21, 2018
(86) PCT No.: PCT/EP2018/057088

§ 371 Date: Aug. 23, 2019

(30) Foreign Application Priority Data
Mar. 23, 2017 (DE) 10 2017 106 250.5

(51) Int. Cl. B60H 1/22; F24H 1/00; F24H 1/16

(52) U.S. Cl. CPC B60H 1/2221; F24H 1/009; F24H 2250/02; B60H 2001/2271; F24H 1/162

(57) ABSTRACT

An electrical heating apparatus for a motor vehicle includes a volume for receiving and conducting a liquid, a liquid inlet and a liquid outlet. The liquid can flow in through the liquid inlet into the volume and can flow out through the liquid outlet. At least one heating element is arranged in the volume. At least one deviating device is provided in such a way that the liquid flowing from the liquid inlet to the liquid outlet is deviated so that a flow path is increased.

### CROSS-REFERENCE TO RELATED APPLICATIONS

This application represents the national stage entry of PCT International Application No. PCT/EP2018/057088 filed on Mar. 21, 2018 and claims priority to German Patent Application DE 10 2017 106 250.5 filed on Mar. 23, 2017. The contents of these applications are hereby incorporated by reference as if set forth in their entirety herein.

### DESCRIPTION

The disclosure relates to an electrical heating apparatus, in particular a parking heater, for a motor vehicle and to a method for operating a heating apparatus.

Electrical heating apparatuses for motor vehicles, for example parking heaters, are widely known. Parking heaters conventionally have a water-carrying region (volume) with a main flow direction. Water connections are furthermore assigned to the water-carrying region, which make it possible to feed water into and out of the water-carrying region. For continuous operation of such a parking heater, it is usually necessary for venting to be made possible. In this context, the use of the available installation space is regarded as worth improving.

It is therefore an object of the disclosure to be able to use available installation space in a motor vehicle efficiently.

This object is achieved by the features of Claim 1.

In particular, the object is achieved by an electrical heating apparatus, preferably a parking heating, for a motor vehicle (for example car or lorry), comprising a volume for receiving and conducting a liquid, in particular water, a liquid inlet and a liquid outlet, in such a way that the liquid can flow in through the liquid inlet into the volume and can flow out through the liquid outlet, wherein at least one (electrical) heating element, in particular an (electrical) heating resistor, is arranged in the volume, wherein at least one deviating device, in particular at least one separating wall, is provided so that the liquid flowing from the liquid inlet to the liquid outlet is deviated (so that a flow path is increased in comparison with an electrical heating apparatus without such a deviating device).

The volume (water-carrying region) is preferably formed by a container in which (at least in sections) the heating element, or in particular the heating resistor, is arranged. The volume, or the container, may in particular be configured to be cuboid (optionally with rounded edges) or (circular-)cylindrical. The container may optionally be formed in one piece (preferably monolithically) with the deviating device. As an alternative, the container may be composed of a plurality of elements and/or the container and deviating device may be formed by separate components. The container may (at least in sections) be made of metal and/or plastic. The liquid inlet and/or outlet preferably have a round cross section. A heating element is in particular intended to mean an element which makes it possible to heat a liquid in the volume, so that the temperature of the liquid when emerging from the liquid outlet is increased relative to the temperature when entering through the liquid inlet. Such a heating element is preferably leaktight (i.e. formed in particular without fluid channels integrated therein). The heating element is preferably an (electrical) heating resistor, i.e. a structure which is heated when an electrical current is applied, in which case the heat may then be dissipated to the liquid in the volume. An arrangement of the heating element in the volume is intended, in particular, to mean an arrangement in which the heating element protrudes into an interior of the volume. It may, however, also be an arrangement in which the heating element is arranged on an internal surface of a wall of the volume or is defined by the wall itself. In one specific embodiment, precisely one liquid inlet and one liquid outlet are provided. It is also conceivable for more than one liquid inlet and/or more than one liquid outlet to be provided. Deviation by the deviating device is intended, in particular, to mean that a direct path between the liquid inlet and the liquid outlet is at least partially blocked by the deviating device, so that the liquid is forced at least partially onto a detour path in order to pass from the liquid inlet to the liquid outlet when flowing through the volume. This is not intended to exclude the possibility that at least a small part of the liquid flowing through the volume may also flow on a direct path from the liquid inlet to the liquid outlet (for example through a narrow opening in the deviating device, which allows at least a small part of the liquid to flow from the liquid inlet to the liquid outlet without a detour path). At least the majority of the liquid should, however, be forced onto a detour path by the deviating device. This detour path should preferably be at least twice as great, preferably at least four times as great, as a (potential) direct path between the liquid inlet and the liquid outlet. In specific configurations, the deviating device may extend over at least 25%, more preferably at least 50% of a distance between two opposite wall sections (for example extending parallel). In the case of an e.g. (circular-) cylindrical configuration, the deviating device may preferably extend over at least 25%, in particular at least 50% of a length of the cylinder.

One key concept of the disclosure is to force the liquid flowing through the volume onto a path by the deviating device so that “shorting” of the liquid from the liquid inlet to the liquid outlet is (at least partially) prevented. In this way (at least independently of an installation position) the heating element can be flowed around well (at least substantially fully) and in a defined way. The nature of the flow around the heating element is therefore (at least substantially) independent of the installation position. Nevertheless, sufficient venting may be made possible in different (for example two or three different) installation positions. Overall, available installation space can therefore be used more efficiently (by corresponding orientation of the electrical heating apparatus). Overall, the electrical heating apparatus can be used variably.

According to an independent aspect of the disclosure (which may preferably be combined with the aspect above), the object is achieved by an electrical heating apparatus (in particular a parking heater) for a motor vehicle, preferably of the type described above, the electrical heating apparatus comprising a volume for receiving and conducting a liquid, in particular water, a liquid inlet and a liquid outlet, in such a way that the liquid can flow in through the liquid inlet into the volume and can flow out through the liquid outlet, wherein a heating resistor is arranged in the volume, wherein the electrical heating apparatus is configured in such a way that it can be mounted and vented in at least two, preferably at least three different installation positions. According to one basic concept of the disclosure, an electrical heating apparatus is thus proposed which is configured so that it functions (continuously), and in particular can be vented, in different installation positions. The electrical heating apparatus is furthermore intended to be configured in such a way that it can be operated (efficiently), i.e. corresponding heat transfer can take place, in the plurality of installation positions. Lastly, the electrical heating apparatus is also configured in such a way that it can be mounted in the different installation positions (installation orientations). This assumes corresponding mounting devices which also allow mounting in the plurality of installation positions (installation orientations). In this case, it should be borne in mind that different forces act in different installation positions, since the force of gravity is always directed downwards. A first installation position may thus initially be made possible. A second installation position may optionally be reached by rotation of the electrical heating apparatus through 90 degrees from the first installation position. An optional third installation position may be reached by rotation through 90 degrees from the second installation position about a second (different) axis. The second axis is preferably perpendicular to the first axis. For example, the first axis may be parallel to a longitudinal extent of the electrical apparatus and the second axis may be perpendicular thereto (i.e. extend transversely). In electrical heating apparatuses, in particular electrical parking heaters, of the prior art, in particular the type of configuration of the through-flow as well as the arrangement of the water connections prevent different installation positions of the heating apparatus from being achieved. This restriction is now overcome, according to the disclosure. In general, different installation positions are intended to mean different orientations of the electrical heating apparatus in relation to the force of gravity vector.

The deviating device (the deviating element, in particular the separating wall) may be made of metal and/or configured in the form of a plate, or as a plate. The deviating elements may, at least in sections, be a (preferably straight) metal plate. A base contour of the deviating element may be square.

The deviating device (the deviating element) may be at a distance from the heating element, i.e. not connected thereto, in particular not in contact with at least one or more or all heating element(s).

The deviating device may be mounted at a proximal end inside the electrical heating apparatus, in particular on a housing or housing part of the electrical heating apparatus. A distal end is preferably free.

Preferably, the liquid inlet and the liquid outlet are arranged next to one another. As an alternative or in addition, the liquid inlet and the liquid outlet may be arranged on the same side (for example in the same wall, in particular side wall) of the electrical heating apparatus (or of a container forming the volume). “Next to one another” is intended in particular to mean a distance of less than 5 cm between the liquid inlet and the liquid outlet. For example, the liquid inlet and the liquid outlet may be arranged on a longitudinally extending wall of the electrical heating apparatus (or of the volume), in particular one end of such a longitudinal wall, in which case this end may be defined by a range of 20% of the longitudinal extent (as seen from an end edge). By such an arrangement, on the one hand venting can be carried out effectively in different installation positions, while at the same time the electrical heating apparatus can operate efficiently since sufficient flow around the heating element is ensured by the deviating device in the different installation positions. Overall, efficient operation is possible in different installation positions, i.e. with efficient use of an available installation space.

The liquid inlet and the liquid outlet may be at a distance from one another which is (significantly) less than a maximum possible distance between two points inside the volume, for example less than half, preferably less than one quarter, preferably less than one eighth of this maximum possible distance. In the case of a (perfect) cuboid, for example, the maximum possible distance would correspond to the spatial diagonals.

Preferably, the liquid outlet is/can be arranged either at the same height as or above the liquid inlet in at least three different installation positions. In one specific embodiment, the liquid outlet is/can be arranged at the height of the liquid inlet in two installation positions and above the liquid inlet in a third installation position. In this way, effective operation as well as venting can be made possible in a straightforward way in three different installation positions.

If the liquid outlet and the liquid inlet are arranged on the same wall (preferably in the case of a cuboid on the same side wall or in the case of a cylinder on the lateral surface) of the volume, the liquid outlet and the liquid inlet are preferably arranged at the same height of this wall, or are arranged so that a connecting line between the liquid inlet and the liquid outlet extends parallel to a wall boundary.

The flow path increased by the deviating device is at least twice, preferably at least four times, more preferably at least eight times, and even more preferably sixteen times as long as a distance between the liquid inlet and the liquid outlet.

Preferably, the deviating device extends inside the volume over at least 50%, preferably at least 80%, more preferably at least 90% and/or at most 95%, preferably at most 92%, of a (longitudinal) extent of the volume.

In one specific embodiment, the deviating device separates the volume into at least two subvolumes, which are preferably connected to one another by at least one or precisely one connecting opening. The connecting opening may be further away from the liquid inlet than the liquid outlet is (from the liquid inlet). As an alternative or in addition, a heating element or a section thereof may be arranged in both subvolumes. A separating surface defined by the deviating device (separating wall) preferably has an opening or openings over at most 20%, more preferably at most 10% (of the area). In other words, the separating surface is predominantly leaktight. In one specific embodiment, there may be a passage between the subvolumes only at a distal end (facing away from the liquid inlet) of the deviating device. Optionally, however, (at least smaller) passages may also be arranged in the direction of the liquid inlet, for example in order to improve the venting and/or flow onto individual regions of the heating element.

The deviating device (separating wall) may be arranged and oriented in such a way that a cross section of a liquid feed perpendicularly to a longitudinal extent of the deviating device narrows or widens in the shape of a funnel starting from the liquid inlet and/or the liquid outlet. The deviating device (separating wall) may extend diagonally from a first side to a second (opposite side, optionally extending parallel). By such narrowing or widening (in the shape of a funnel), flow through the volume can be achieved effectively (even in different installation positions), which improves the efficiency overall.

A housing, defining the volume, and the deviating device may be produced as a one-piece (monolithic) component. In this way, the production cost may be reduced and (additional) sealing positions may be avoided.

Preferably, at least one tubular heating body and/or at least one layer heater is provided as the heating element or a part thereof. A tubular heating body may, in particular, be taken to mean a meandering and/or screw- and/or spiral-shaped profile of an (optionally leaktight, i.e. without internal fluid channels) electrical conductor. A layer heater is, in particular, a heating element in which an electrical conductor is applied flat (for example over at least 5 cm² or 10 cm²) onto a support (for example the housing inner wall) and has an electrical current applied to it for heating. For example, in this regard reference is made to WO 2013/186106 A1 and WO 2013/030048 A1. Heaters are described therein which comprise an electrical heating layer that is heated when an electrical voltage (or the flow of the current) is applied. The use of a tubular heating body makes it possible, in particular, to implement a geometry which is simple to manufacture.

The object mentioned above is furthermore achieved by a motor vehicle comprising an electrical heating apparatus of the type described above.

The object is furthermore achieved by a method for operating a heating apparatus of the type described above or of a motor vehicle of the type described above, wherein the liquid flows in through the liquid inlet and flows out from the liquid outlet with an increased temperature. The liquid flowing out of the volume is preferably used to heat an interior of a motor vehicle, in particular a passenger seat, and/or to heat (or preheat) a propulsion element, in particular an engine.

According to another aspect of the disclosure, the use of a heating apparatus of the type described above as a preheating device and/or auxiliary heating device, in particular as a parking heater, is proposed.

The heating element (the electrical heating resistor) may be supplied with current by means of a current supply of the motor vehicle (for example a vehicle battery) and/or by means of an (external) electricity network.

The subvolumes respectively comprise at least 10%, preferably at least 20%, more preferably at least 40% of the (total) volume.

The volume may comprise at least 200 cm³, preferably 1000 cm³. Furthermore, the volume may be at least 5 cm, preferably at least 12 cm long (in a longitudinal extent). An upper limit may be 40 cm, preferably 30 cm. A width and/or depth and/or (for example in the case of a cylindrical embodiment) a diameter may for example be at least 4 cm, preferably at least 6 cm. A corresponding upper limit may be 12 cm, preferably 8 cm.

For mounting at the installation position, the electrical heating apparatus preferably comprises corresponding fastening devices (for example bores).

The disclosure will be described below with the aid of an exemplary embodiment, which will be explained in more detail with the aid of figures, in which:

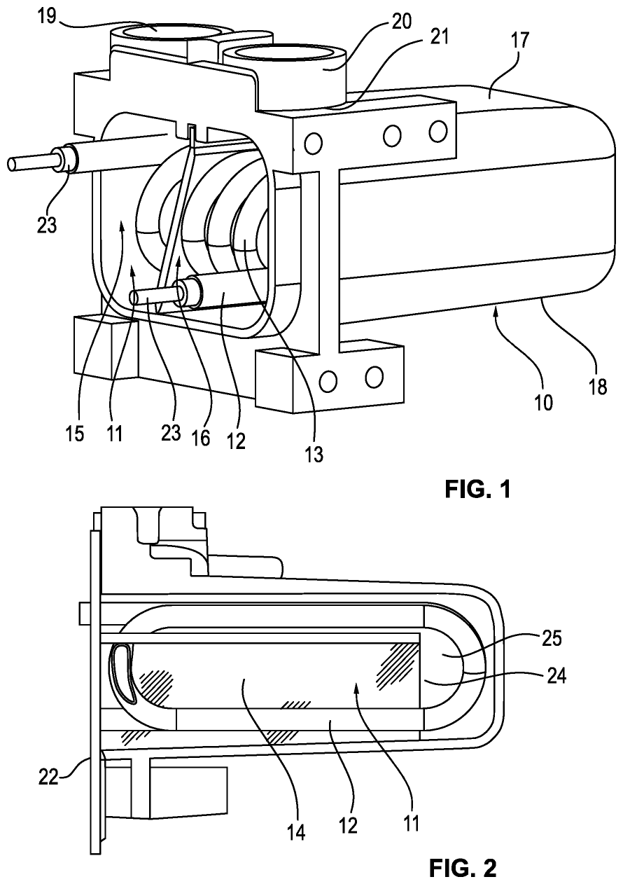

FIG. 1 shows a schematic oblique view of a heating apparatus according to the disclosure;

FIG. 2 shows a side view (with partially transparently represented or permitted walls) of the heating apparatus according FIG. 1.

In the description below, the same references are used for parts which are the same and parts which have the same effect.

FIG. 1 shows a schematic oblique view of a heating apparatus according to the disclosure (whether the wall element 22 which can be seen in FIG. 2, so that it is possible to see partially into an interior of the electrical heating apparatus). A housing 10 of the heating apparatus is configured to be (approximately) cuboid (with rounded edges), so that a corresponding volume 11, which is defined by the housing 10, is also configured to be cuboid (with rounded edges). Inside the volume 11, there is a heating element 12, which in the present exemplary embodiment comprises a tubular heating body. In the presence of an electrical current, this tubular heating body 13 is heated so that a liquid (water) in the volume 11 can be heated.

The volume 11 is subdivided by a separating wall 14 (separating metal plate) into two subvolumes 15, 16. The separating wall 14 in this case extends diagonally (obliquely) from one (longitudinal) side wall 17 to an opposite side wall 18. On the side wall 17, there is a liquid inlet 19 and a liquid outlet 20 (specifically next to one another in relation to a longitudinal extent of the housing 10). Specifically, the liquid inlet 19 and the liquid outlet 20 are located in an end section 21 of the side wall 17. As an alternative, the liquid inlet may also be arranged at the reference 20 and the liquid outlet may be arranged at the reference 19.

Bores 21 can also be seen, which make it possible to mount the heating device.

FIG. 2 shows a side view of the electrical heating device according to FIG. 1, some elements (in particular walls) being represented transparently. In particular, it can be seen from FIG. 2 that the electrical heating resistor (heating element) 12 extends over (almost) the entire longitudinal extent of the volume (at least over 90% of this longitudinal extent). The heating resistor thus extends from one wall 22, through the heating element terminals 23, (almost) to the opposite wall 23. A distal end 24 of the separating wall 14 is likewise indicated in FIG. 2. It can furthermore be seen that the separating wall 14 extends from the wall 22 far into the volume (over more than ¾ of a longitudinal extent of the volume), but preferably not as far as the heating element 12. In any event, the liquid can flow around the distal end 24 through a connecting opening 25 from one subvolume into the other subvolume, so that liquid can flow from the liquid inlet 19 to the liquid outlet 20.

FIGS. 1 and 2 show a first installation position (horizontal), in which the water connections (liquid inlet 19 and liquid outlet 20) are arranged at one end on the side wall 17 (which in this case defines an upper side of the volume or water-carrying region).

In a second (possible) installation position (rotated through 90 degrees about a longitudinal axis), the water connections are located laterally (on a wall which is then oriented vertically) with respect to the water-carrying region (volume), the liquid outlet being located above the liquid inlet.

In a third (possible) installation position (“vertical”; rotated through 90 degrees about the transverse axis from the horizontal installation position), the water connections (liquid inlet 19 and liquid outlet 20) are arranged laterally at the upper end of the volume (water-carrying region). The fact that the volume 11 is subdivided into subvolumes 15, 16 ensures that liquid (water) does not flow directly from the liquid inlet to the liquid outlet 20 and thus avoid the heating element 12. The subdivision is made possible by the separating wall 14 (separating metal plate). The separating wall 14 is preferably made of metal and configured in the form of a plate (a thickness of the separating wall is preferably less than 4 mm, more preferably less than 2 mm). The deviating element (the separating wall 14) is arranged between the two water connections (liquid inlet 19 and liquid outlet 20) and this divides the water-carrying region (the volume) into two parts. A recess for flow over or around the separating wall 14 may optionally be provided only in the region which is at the greatest distance from the water connections (i.e. at the very bottom in a horizontal installation position), so that the water must flow around the entire heating element. For the purpose of venting or for controlled flow onto individual regions of the heating element, however, it may also be possible to a certain extent to provide further passages in the separating wall 14 (separating metal plate).

At this point, it should be pointed out that all parts described above are claimed as essential to the disclosure on their own or in any combination, in particular the details represented in the drawings. Variants thereof are familiar to the person skilled in the art.

### REFERENCES

10 housing
11 volume
12 heating element
13 tubular heating body
14 deviating device (separating wall)
15 subvolume
16 subvolume
17 side wall
18 side wall
19 liquid inlet
20 liquid outlet
21 bore
22 wall
23 wall
24 distal end
25 connecting opening

1. Electrical heating apparatus for a motor vehicle, comprising a volume for receiving and conducting a liquid, a liquid inlet and a liquid outlet, in such a way that the liquid can flow in through the liquid inlet into the volume and can flow out through the liquid outlet,
wherein at least one heating element is arranged in the volume,
wherein at least one deviating device is provided in such a way that the liquid flowing from the liquid inlet to the liquid outlet is deviated so that a flow path is increased.

2. Electrical heating apparatus for a motor vehicle comprising a volume for receiving and conducting a liquid, a liquid inlet and a liquid outlet, in such a way that the liquid can flow in through the liquid inlet into the volume and can flow out through the liquid outlet,
wherein a heating element is arranged in the volume,
wherein the electrical heating apparatus is configured in such a way that it can be mounted and vented in at least two different installation positions.

3. Electrical heating apparatus according to claim 1,
wherein
the liquid inlet and the liquid outlet are arranged next to one another and/or on the same side of the electrical heating apparatus.

4. Electrical heating apparatus according to claim 1, wherein the liquid inlet and the liquid outlet are at a distance from one another which is less than half a maximum possible distance between two points inside the volume.

5. Electrical heating apparatus according to claim 1, wherein the liquid outlet lies either at the same height as or above the liquid inlet in at least three different installation positions.

6. Electrical heating apparatus according to claim 1, wherein the flow path increased by the deviating device is at least twice a distance between the liquid inlet and the liquid outlet.

7. Electrical heating apparatus according to claim 1, wherein the deviating device separates the volume into at least two subvolumes which are connected to one another by at least one or precisely one connecting opening, the connecting opening being further away from the liquid inlet than the liquid outlet is, and/or a heating element or a section thereof being arranged in both subvolumes.

8. Electrical heating apparatus according to claim 1, wherein the deviating device is arranged and oriented in such a way that a cross section of a liquid feed perpendicularly to a longitudinal extent of the deviating device narrows or widens in the shape of a funnel starting from the liquid inlet and/or the liquid outlet, and/or the deviating device extends diagonally from a first side to a second side.

9. Electrical heating apparatus according to claim 1, wherein at least one tubular heating body and/or at least one layer heater is provided as the heating element or a part thereof.

10. Motor vehicle comprising an electrical heating apparatus according to claim 1.

11. Method for operating a heating apparatus according to claim 1, wherein the liquid flows in through the liquid inlet and flows out from the liquid outlet with an increased temperature.

12. Method according to claim 11, wherein the liquid flowing out of the volume is used to heat an interior of a motor vehicle and/or to heat a propulsion element.

13. Use of a heating apparatus according to claim 1 as a preheating device and/or auxiliary heating device.

14. Electrical heating apparatus according to claim 1, wherein the electrical heating apparatus is a parking heater.

15. Electrical heating apparatus according to claim 1, wherein the liquid is water.

16. Electrical heating apparatus according to claim 1, wherein the heating element is a heating resistor.

17. Electrical heating apparatus according to claim 4, wherein the liquid inlet and the liquid outlet are at a distance from one another which is less than one quarter of the maximum possible distance.

18. Electrical heating apparatus according to claim 6, wherein the flow path increased by the deviating device is at least eight times a distance between the liquid inlet and the liquid outlet.

19. Electrical heating apparatus according to claim 1, wherein the deviating device is a separating wall.

20. Method according to claim 12, wherein the liquid flowing out of the volume is used to heat a passenger seat, and/or an engine.
